(19) United States
(12) Patent Application Publication
(10) Pub. No.: US 2026/0008451 A1
(43) Pub. Date: Jan. 8, 2026

(54) VEHICLE CONTROL METHOD AND VEHICLE CONTROL DEVICE

(71) Applicant: Panasonic Automotive Systems Co., Ltd., Kanagawa (JP)

(72) Inventors: Toyoharu KURODA, Osaka Fu (JP); Hirofumi NISHIMURA, Kanagawa Ken (JP); Maiko OTANI, Kanagawa Ken (JP)

(73) Assignee: Panasonic Automotive Systems Co., Ltd., Kanagawa (JP)

(21) Appl. No.: 19/257,746

(22) Filed: Jul. 2, 2025

(30) Foreign Application Priority Data
Jul. 5, 2024 (JP) 2024-108568

(51) Int. Cl. B60W 30/06; B60W 10/18; B60W 10/20; B60W 50/14; B60W 60/00

(52) U.S. Cl. CPC B60W 30/06; B60W 10/20; B60W 50/14; B60W 60/001; B60W 10/18; B60W 2050/146

(57) ABSTRACT

A vehicle control method includes: controlling at least steering to cause a vehicle to perform autonomous traveling from a parking position to a target exiting position based on an exiting path in a case where the exiting path from the parking position to the target exiting position has been registered when starting exiting from the parking position; causing the display device to display first information prompting an occupant to determine whether or not to register the exiting path in a case where the exiting path has not been registered when starting the exiting from the parking position; and causing the vehicle to travel from the parking position to the target exiting position according to the operation by the occupant, and registering, as the exiting path, a traveling path along which traveling has been performed from the parking position to the target exiting position.

### CROSS-REFERENCE TO RELATED APPLICATIONS

This application is based upon and claims the benefit of priority from Japanese Patent Application No. 2024-108568, filed on Jul. 5, 2024, the entire contents of which are incorporated herein by reference.

### FIELD

The present disclosure relates to a vehicle control method and a vehicle control device.

### BACKGROUND

A vehicle control device that supports autonomous traveling of a vehicle is known. For example, a technique in which a traveling trajectory until the vehicle performs entering in a parking position is stored, and in a case where the vehicle performs exiting from the parking position, a path obtained by reversing the traveling trajectory is generated as a planned traveling path for exiting, and the vehicle autonomously travels along the planned traveling path is disclosed.

A related technique is described in Patent Literature 1: JP 2020-185875 A.

However, for example, a path obtained by reversing a traveling path until the vehicle performs the entering in the parking position may be different from an exiting path desired by an occupant, or a partial path where exiting traveling is impossible may be included, and thus, it may be difficult to use the path as the exiting path from the parking position. That is, it is difficult to provide suitable exiting assistance with the related art.

### SUMMARY

A vehicle control method according to the present disclosure is executed by a vehicle control device mounted on a vehicle including an operation device that receives an operation of an occupant, a sensor device that acquires an outside situation, a display device that is visually recognizable by the occupant, and a movement control device that controls at least steering. The vehicle control method includes: controlling at least steering to cause the vehicle to perform autonomous traveling from a parking position to a target exiting position based on an exiting path in a case where the exiting path from the parking position to the target exiting position has been registered when starting exiting from the parking position; causing the display device to display first information prompting the occupant to determine whether or not to register the exiting path in a case where the exiting path from the parking position to the target exiting position has not been registered when starting the exiting from the parking position; and causing the vehicle to travel from the parking position to the target exiting position according to the operation by the occupant received by the operation device, and registering, as the exiting path, a traveling path along which traveling has been performed from the parking position to the target exiting position in a case where the operation device has received a registration start instruction operation for the exiting path by the occupant.

### BRIEF DESCRIPTION OF THE DRAWINGS

FIG. 1 is a block diagram illustrating an example of an overall configuration of a vehicle;

FIG. 2 is a schematic diagram illustrating an example of disposition of cameras;

FIG. 3 is an explanatory diagram of an example of a taught path;

FIG. 4 is a schematic diagram of an example of a data configuration of a path management database (DB);

FIG. 5A is a schematic diagram of an example of a screen;

FIG. 5B is a schematic diagram of an example of a screen;

FIG. 5C is a schematic diagram of an example of a screen;

FIG. 6A is a schematic diagram of an example of a screen;

FIG. 6B is a schematic diagram of an example of a screen;

FIG. 7A is a schematic diagram of an example of a screen;

FIG. 7B is a schematic diagram of an example of a screen;

FIG. 7C is a schematic diagram of an example of a screen;

FIG. 8 is a flowchart illustrating an example of a flow of registration processing for entering path data and map data by teaching traveling at the time of entering;

FIG. 9 is a flowchart illustrating an example of a flow of information processing executed by a vehicle control device at the time of exiting; and

FIG. 10 is a block diagram illustrating a hardware configuration example of the vehicle control device.

### DETAILED DESCRIPTION

Hereinafter, embodiments of a vehicle control method and a vehicle control device according to the present disclosure will be described with reference to the drawings.

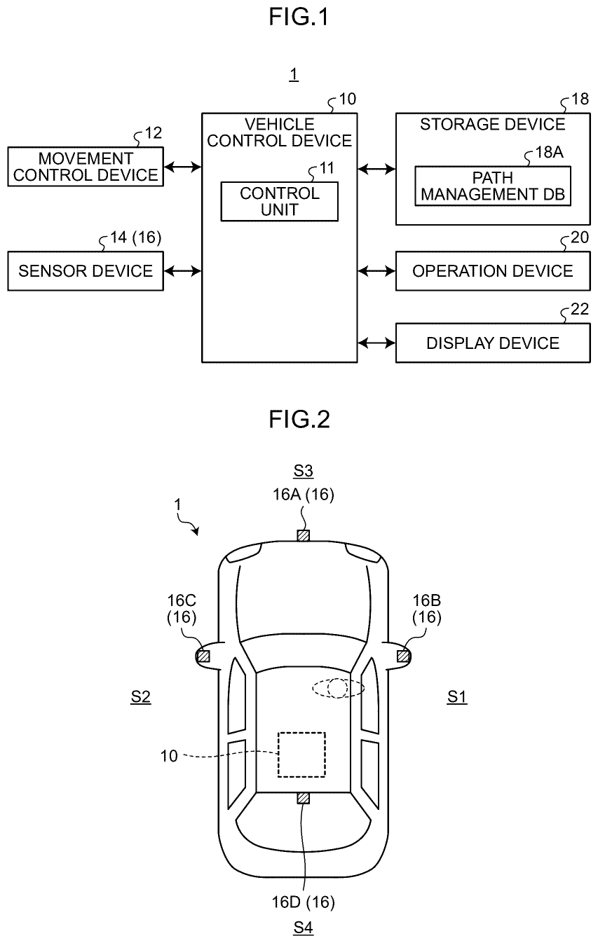

FIG. 1 is a block diagram illustrating an example of an overall configuration of a vehicle 1.

The vehicle 1 includes a vehicle control device 10, a movement control device 12, a sensor device 14, a storage device 18, an operation device 20, and a display device 22.

The movement control device 12, the sensor device 14, the storage device 18, the operation device 20, and the display device 22 are connected to the vehicle control device 10 so as to be able to exchange data or a signal. That is, the vehicle control device 10 is set to be communicably connected to at least the sensor device 14, the operation device 20, the display device 22, and the movement control device 12.

The movement control device 12 controls at least steering, acceleration, and deceleration of the vehicle 1. The movement control device 12 is means for implementing driving, braking, and turning motions necessary for traveling of the vehicle 1. For example, the movement control device 12 includes a drive motor, a power transmission mechanism, a brake device, a steering device, and the like, and an electronic vehicle control device that controls the drive motor, the power transmission mechanism, the brake device, the steering device, and the like. The movement control device 12 causes the vehicle 1 to travel by, for example, generating power with the drive motor and transmitting the power to wheels via the power transmission mechanism. The power transmission mechanism is, for example, a propeller shaft, a differential gear, a drive shaft, or the like.

Controlling at least the acceleration and deceleration means that the movement control device 12 controls at least one of the driving and braking necessary for the traveling of the vehicle 1. That is, controlling the acceleration and deceleration means that the movement control device 12 controls an acceleration applied during the acceleration and a deceleration which is an acceleration applied during the deceleration. Specifically, controlling the acceleration and deceleration means that the movement control device 12 controls an acceleration and a deceleration by an accelerator operation, controls the deceleration or stop by a brake operation, and controls an acceleration and a deceleration according to an outside situation during autonomous traveling or the like.

Controlling at least the steering means that the movement control device 12 controls at least one of the driving, braking, and turning motions necessary for the traveling of the vehicle 1. That is, controlling the steering means that the movement control device 12 controls a turning direction by the steering.

The sensor device 14 is mounted on the vehicle 1 and acquires at least an outside situation of the vehicle 1. Specifically, the sensor device 14 includes various sensors that detect a traveling state of the vehicle 1 and the outside situation of the vehicle 1. The outside situation includes a video of an area outside the vehicle 1.

The sensor device 14 includes at least a camera 16. In addition, the sensor device 14 includes at least one of a light detection and ranging (LiDAR), a radar, a sonar, and an ultrasonic sensor. In addition, the sensor device 14 includes an accelerator pedal position sensor that detects an accelerator pedal position, a steering angle sensor that detects a steering angle of the steering device, a steering wheel rotation operation angle detection sensor that detects an angle of a steering wheel rotation operation of a steering wheel, an acceleration sensor that detects the acceleration applied during the acceleration and the deceleration of the vehicle 1, a torque sensor that detects a torque acting on the power transmission mechanism between the wheels of the vehicle 1 and the drive motor, a vehicle speed sensor that detects a vehicle speed of the vehicle 1, a wheel speed sensor, a sensor that detects a shift state of the vehicle 1, and the like. Examples of the sensor that detects the shift state include a gear position sensor.

The camera 16 is a surrounding sensor that is mounted on the vehicle 1 and monitors a surrounding environment of the vehicle 1. In the present embodiment, the camera 16 captures the surroundings of the vehicle 1 and outputs captured video data to the vehicle control device 10. Hereinafter, the captured video data may be simply referred to as a video. Furthermore, in the present embodiment, the camera 16 is also applied to an application of detecting an object present around the vehicle 1 and estimating a position where the vehicle 1 is present from a positional relationship between the vehicle 1 and the object present around the vehicle 1.

A position of the camera 16, the number of installed cameras, and a capturing direction of the camera are adjusted in advance such that the surroundings of the vehicle 1 can be captured.

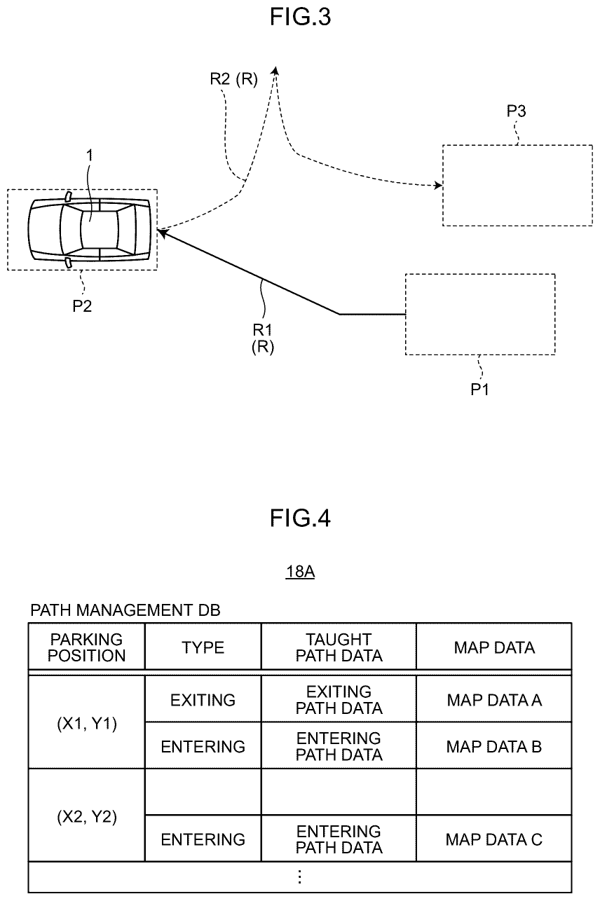

FIG. 2 is a schematic diagram illustrating an example of disposition of the camera 16.

The vehicle 1 is provided with, for example, four cameras 16 so as to be able to acquire the outside situation of the vehicle 1 in at least four directions of a first side S1, a second side S2, a front side S3, and a rear side S4 of the vehicle 1. The first side S1 is one side direction of the vehicle 1. The second side S2 is a side of the vehicle 1 that is opposite to the first side S1.

Specifically, the camera 16 includes a first camera 16A, a second camera 16B, a third camera 16C, and a fourth camera 16D. The first camera 16A is disposed at a front portion of the vehicle 1 and captures an image of the front side S3 of the vehicle 1. The second camera 16B is disposed at a right portion of the vehicle 1 and captures an image of the first side S1 of the vehicle 1. The third camera 16C is disposed at a left portion of the vehicle 1 and captures an image of the second side S2 of the vehicle 1. The fourth camera 16D is disposed at a rear portion of the vehicle 1 and captures an image of the rear side S4 of the vehicle 1. The number of cameras 16 provided in the vehicle 1 is not limited to four. As for sensors that detect an object, such as the LiDAR, the radar, the sonar, and the ultrasonic sensor included in the sensor device 14, it is preferable that a disposition position, the number of disposed sensors, and the like are adjusted in advance such that the outside situation of each of the first side S1, the second side S2, the front side S3, and the rear side S4 of the vehicle 1 can be acquired.

Returning to FIG. 1, the description continues. The sensor device 14 outputs sensor information obtained by the detection to the vehicle control device 10. The sensor information includes a detection result of the sensor device 14 such as the LiDAR, the radar, the sonar, the ultrasonic sensor, the accelerator pedal position sensor, the steering angle sensor, the angle of the steering wheel rotation operation, the acceleration applied during the acceleration of the vehicle 1, the deceleration, the torque, the vehicle speed, the shift state, or the like.

The storage device 18 stores various data. In the present embodiment, a path management database (DB) 18A is stored in the storage device 18. Details of the path management DB 18A are described below.

The storage device 18 is, for example, an auxiliary storage device such as a hard disk drive (HDD), a solid state drive (SSD), or a flash memory. At least part of the data included in the storage device 18 may be stored in an external storage device such as a server device provided outside the vehicle 1 and communicably connected to the vehicle control device 10.

The operation device 20 receives an operation by an occupant of the vehicle 1. The operation device 20 includes a steering device such as the steering wheel, an operation mechanism related to a driving operation such as an accelerator pedal, a brake pedal, a turn signal lever, a shift lever, and a push-button switch, and an input device such as a keyboard, a touch panel, or a switch. The shift of the vehicle 1 switched by the operation device 20 includes parking for fixing a gear of the parked vehicle 1. The operation device 20 may form a part of at least one of a human machine interface (HMI) and an in-vehicle infotainment (IVI).

The display device 22 is a display that outputs various images. The display device 22 is installed at a position visually recognizable by the occupant of the vehicle 1. Examples of the display include a liquid crystal display (LCD), an organic electro-luminescence (EL) display, and a projector. The display may also be a touch panel display in which the display device 22 and the operation device 20 are integrally configured. The display device 22 is an example of the HMI.

The vehicle control device 10 is an electronic control unit that integrally controls the respective units of the vehicle 1.

The vehicle control device 10 control the movement control device 12 such that the traveling state of the vehicle 1 is optimized by using the sensor information received from the sensor device 14. In addition, the vehicle control device 10 controls the movement control device 12 to cause the vehicle 1 to perform the autonomous traveling.

The vehicle control device 10 includes a control unit 11. A part of or the entire control unit 11 may have a software configuration implemented by cooperation of a processor and various programs stored in a memory. In addition, a part of or the entire control unit 11 may have a hardware configuration implemented by a dedicated circuit or the like. Circuitry may include at least one of the software configuration and the software configuration.

The control unit 11 integrally controls the respective units of the vehicle 1.

In the present embodiment, the control unit 11 is configured to be able to switch a traveling mode to a teaching traveling mode or an autonomous traveling mode based on an input operation or the like of the operation device 20 by the occupant. The traveling mode executable by the vehicle 1 may include various traveling modes other than the teaching traveling mode and the autonomous traveling mode.

The teaching traveling mode is a mode for registering a taught path when causing the vehicle 1 to perform autonomous traveling. The taught path is a path obtained by performing teaching traveling from a predetermined position to a target position. In the teaching traveling mode, the vehicle 1 is controlled to travel by an operation of the occupant. That is, in the teaching traveling mode, the operation device 20 receives an operation, which is the driving operation by the occupant, and the control unit 11 controls the movement control device 12 to perform traveling according to the operation. In other words, in the teaching traveling mode, the control unit 11 registers the taught path based on the outside situation acquired by the sensor device 14 during the teaching traveling in which the vehicle 1 travels from the predetermined position to the target position by the operation of the occupant. Hereinafter, the outside situation acquired by the sensor device 14 during the teaching traveling will be referred to as a first situation.

The autonomous traveling mode is a mode in which the vehicle 1 performs the autonomous traveling. In the present embodiment, the autonomous traveling mode means a mode in which the vehicle 1 performs the autonomous traveling along the taught path. In the autonomous traveling mode, the control unit 11 controls the movement control device 12 to control at least the steering to perform traveling along the taught path. In the autonomous traveling mode, the vehicle 1 is automatically controlled to travel by the vehicle control device 10 without a manual operation by the occupant. That is, in the autonomous traveling mode, the control unit 11 causes the vehicle 1 to perform the autonomous traveling by controlling at least the steering from the predetermined position to the target parking position based on the outside situation acquired by the sensor device 14 based on the taught path. Hereinafter, the outside situation acquired by the sensor device 14 during the autonomous traveling will be referred to as a second situation.

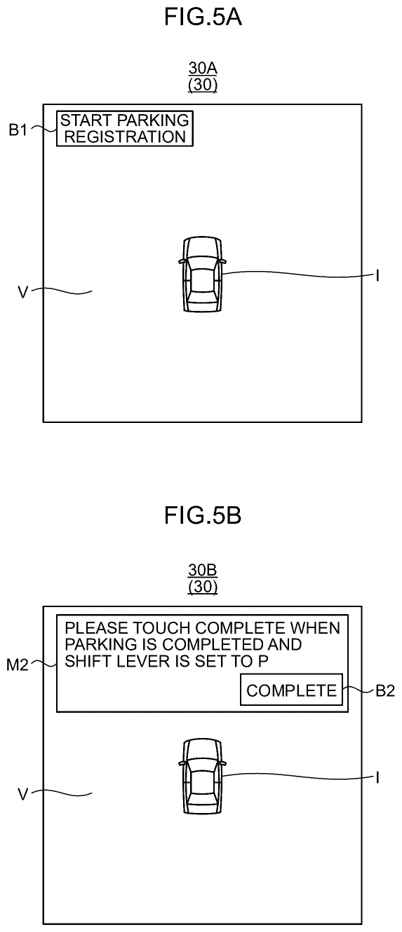

FIG. 3 is an explanatory diagram of an example of a taught path RA.

In the present embodiment, a description will be given of a mode in which the taught path RA includes an entering path R1 which is a traveling path R from a parking start position P1 to a parking position P2 and an exiting path R2 which is a traveling path R from the parking position P2 to a target exiting position P3.

Exiting means that the vehicle 1 travels from the parking position P2 to the outside of the parking position P2. The entering means that the vehicle 1 travels from the outside of the parking position P2 to the parking position P2.

For example, the teaching traveling from the parking start position P1 to the parking position P2 will be described. In the teaching traveling mode for the entering in the parking position P2, the teaching traveling from the parking start position P1 to the parking position P2 is performed by a manual operation of the operation device 20 by the occupant. The parking position P2 is, for example, a parking lot, but is not limited thereto. Further, it is sufficient if the parking start position P1 is any position of the occupant in a real space.

The traveling path R along which the traveling has been performed by the teaching traveling from the parking start position P1 to the parking position P2 is treated as the entering path R1 which is an example of the taught path RA, and the entering path R1 is stored in the storage device 18. At the time of the teaching traveling for the entering, for example, the occupant operates the operation device 20 so as to travel from the parking start position P1 toward the parking position P2. In a case where the vehicle 1 travels from the parking start position P1 toward the parking position P2 at the time of the teaching traveling for the entering, the control unit 11 creates entering path data of the entering path R1 in a traveling direction of the traveling path R from the parking start position P1 to the parking position P2 during the teaching traveling. The entering path data is an example of taught path data of the taught path RA.

Further, for example, the teaching traveling from the parking position P2 to the target exiting position P3 will be described. In the teaching traveling mode for the exiting from the parking start position P1 to the target exiting position P3, the teaching traveling from the parking position P2 to the target exiting position P3 is performed by a manual operation of the operation device 20 by the occupant. It is sufficient if the target exiting position P3 is any position of the occupant in the real space.

The traveling path R along which the traveling has been performed by the teaching traveling from the parking position P2 to the target exiting position P3 is treated as the exiting path R2 which is an example of the taught path RA, and the exiting path R2 is stored in the storage device 18. At the time of the teaching traveling for the exiting, for example, the occupant operates the operation device 20 so as to travel from the parking position P2 toward the target exiting position P3. In a case where the vehicle 1 travels from the parking position P2 toward the target exiting position P3 during the teaching traveling for the exiting, the control unit 11 creates exiting path data of the exiting path R2 in a traveling direction of the traveling path R from the parking position P2 to the target exiting position P3 during the teaching traveling. The exiting path data is an example of taught path data of the taught path RA.

In the autonomous traveling mode, the control unit 11 controls at least the steering along the taught path RA obtained by the teaching traveling, and causes the vehicle 1 to perform the autonomous traveling based on the taught path RA and the second situation. In the autonomous traveling mode, the control unit 11 performs steering control and front and rear acceleration and deceleration control of the vehicle 1, and at least a part of the front and rear acceleration and deceleration control may be performed by an operation of a driver.

Next, control by the control unit 11 in each of the teaching traveling mode and the autonomous traveling mode will be described in detail.

Teaching Traveling Mode First, the control by the control unit 11 in the teaching traveling mode will be described in detail.

When it is determined to start the teaching traveling mode, the control unit 11 switches the traveling mode to the teaching traveling mode. Then, the control unit 11 executes the following processing in the teaching traveling mode.

The control unit 11 acquires the sensor information indicating the traveling state of the vehicle 1 from the sensor device 14. Then, the control unit 11 estimates a current position of the vehicle 1 based on a temporal change of a sensor value indicated by the sensor information. For example, the control unit 11 calculates a movement amount of the vehicle 1 from a reference position such as a traveling start position when the teaching traveling mode is started based on a temporal change of the vehicle speed and a yaw rate represented by the sensor values, and estimates the current position of the vehicle 1 based on the movement amount.

Accuracy in estimation of the current position based on the movement amount may be low. Therefore, the control unit 11 may use, as the current position, a result of correcting the estimated current position based on the video of the surroundings of the vehicle 1 acquired by the camera 16.

The control unit 11 sequentially stores, in the storage device 18, the current positions of the vehicle 1 sequentially estimated during the traveling of the vehicle 1. Specifically, the control unit 11 sets, as the taught path RA, the traveling path R during the teaching traveling represented by a group of the current positions sequentially estimated from a time point when a start instruction for the teaching traveling mode is received to a time point when an end instruction for the teaching traveling mode is received, and stores the taught path data indicating the taught path RA in the storage device 18. In addition, the control unit 11 stores map data in the storage device 18.

The taught path data includes a group of pieces of traveling information for each of positions which are the current positions sequentially estimated during the teaching traveling. The traveling information includes an INDEX, a traveling position, an azimuth, a traveling direction, and reference traveling information. The INDEX is identification information of the traveling information. The traveling position is an estimated position of the vehicle 1. The azimuth indicates the orientation of the vehicle 1 at the position. The traveling direction indicates the traveling direction of the vehicle 1 at the position, and is represented by, for example, forward or backward. The reference traveling information is information indicating the traveling state or the like at the position. The reference traveling information is, for example, information such as a steering angle detected at each position during the teaching traveling, the vehicle speed, and the outside situation acquired by the sensor device 14.

In addition, the control unit 11 creates the map data for estimating the current position of the vehicle 1 from the video captured by the camera 16 during the teaching traveling of the vehicle 1. As a method for estimating the current position of the vehicle 1 from the video, a simultaneous localization and mapping (SLAM) method or the like is used.

The map data is map data in which a plurality of first feature points around the vehicle 1 during the traveling along the taught path RA are registered.

The first feature point is a feature point obtained by analyzing the first situation such as the video captured by the camera 16 during the teaching traveling. That is, in the present embodiment, the feature point specified according to the first situation during the teaching traveling will be referred to as the first feature point.

For example, the feature point is a portion where a characteristic image pattern can be obtained by video analysis in an object (for example, a tree, a wall, or a column) included in a real view. The portion is, for example, an edge portion of the object. As described above, in the present embodiment, the feature point specified during the teaching traveling will be referred to as the first feature point. Therefore, the map data includes the plurality of first feature points, and each of the first feature points is identifiably registered for each first feature point by being assigned an identification number.

The feature point is indicated by feature point data including a three-dimensional position and a feature amount. The three-dimensional position of the feature point is the three-dimensional position of the feature point in the real space, and is represented by, for example, a three-dimensional orthogonal coordinate system (X, Y, Z).

The feature amount of the feature point is a characteristic amount represented by the image analysis of the video of the feature point. The feature amount of the first feature point is, for example, a luminance and a density on the video, a scale invariant feature transform (SIFT) feature amount, a speeded up robust features (SURF) feature amount, or the like.

In the map data, one first feature point is registered for each identical three-dimensional position. For the identical three-dimensional position, the plurality of first feature points may be registered in the map data for each capturing position and capturing direction of the camera 16 at the three-dimensional position. In addition, the feature point data of the first feature point registered in the map data may further include image data of the object having the first feature point.

During the teaching traveling, the control unit 11 specifies coordinates of the first feature point in the real view from the first situation using, for example, stereo photogrammetry. Specifically, the control unit 11 reads a plurality of captured images captured at different timings and forming the video included in the first situation, and associates the same first feature point commonly appearing in the plurality of captured images. Then, for example, the control unit 11 estimates a temporary position of the vehicle 1 when the plurality of captured images are captured, and specifies temporary coordinates of the first feature point in the real view according to a principle of triangulation. Then, for example, the control unit 11 performs bundle adjustment by using the temporary position of the vehicle 1 and the temporary coordinates of the first feature point in the real view as reference information, and calculates a formal position of the vehicle 1 and formal coordinates of the first feature point in the real view so as to minimize a reprojection error when each first feature point in the real view is projected on all the captured images. Then, the control unit 11 stores, in the storage device 18, the map data in which the first feature point indicated by the feature point data including the formal coordinates of the first feature point in the real view as the three-dimensional position is registered.

The three-dimensional position of the first feature point registered in the map data may be a position measured in advance using the LiDAR or a stereo camera without using the SLAM method. However, from the viewpoint of suppressing a decrease in position estimation accuracy, it is preferable to use the SLAM method.

Returning to FIG. 1, the description continues.

As described above, the control unit 11 executes the above-described processing in the teaching traveling mode. Therefore, in the teaching traveling mode, the control unit 11 registers the taught path data of the taught path RA and the map data based on the outside first situation acquired by the sensor device 14 during the teaching traveling. In other words, the control unit 11 generates the taught path data of the taught path RA obtained by the teaching traveling and the map data in which the three-dimensional position of each of the plurality of first feature points around the vehicle 1 during the traveling along the taught path RA and the feature amount of the first feature point are registered based on the first situation, and stores the pieces of generated data in association with each other in the path management DB 18A of the storage device 18.

Therefore, for each teaching traveling, the taught path data of the taught path RA including the group of pieces of traveling information for each of the positions that are the current positions sequentially estimated during the teaching traveling and the map data in which the first feature point observed for each position is registered are registered in association with each other in the path management DB 18A of the storage device 18.

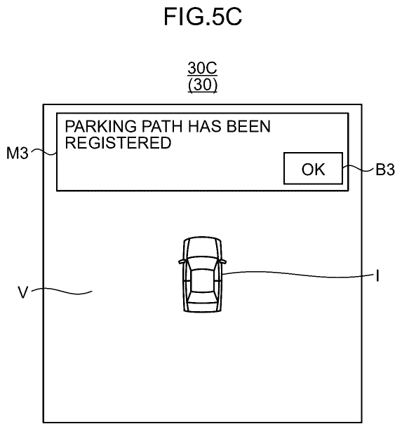

FIG. 4 is a schematic diagram of an example of a data configuration of the path management DB 18A. The path management DB 18A is a database for registering the taught path data and the map data for each taught path. A data format of the path management DB 18A is not limited to the database.

For example, a case of the teaching traveling at the time of the entering from the parking start position P1 to the parking position P2 will be described. In this case, the control unit 11 registers the entering path data of the entering path R1, which is the taught path data of the taught path RA along which the traveling has been performed by the teaching traveling from the parking start position P1 to the parking position P2, the map data generated during the teaching traveling, a type of the taught path RA, and position information of the parking position P2 in association with each other in the path management DB 18A.

It is sufficient if the position information of the parking position P2 is position information indicating a parking region of the vehicle 1 represented by the parking position P2. The position information of the parking position P2 is represented by, for example, position coordinates of one specific point in the parking region of the vehicle 1 represented by the parking position P2, or a position coordinate group representing a position in the parking region. In the present embodiment, a mode in which the position information of the parking position P2 is a position coordinate group representing a position in the parking region represented by the parking position P2 will be described as an example.

The type of the taught path RA is information indicating whether the taught path RA is the entering path R1 or the exiting path R2. In the present embodiment, the control unit 11 registers “entering” in the path management DB 18A as a type corresponding to the entering path data.

In addition, a case of the teaching traveling at the time of the exiting from the parking position P2 to the target exiting position P3 will be described. In this case, the control unit 11 registers the exiting path data of the exiting path R2, which is the taught path data of the taught path RA along which the traveling has been performed by the teaching traveling from the parking position P2 to the target exiting position P3, the map data generated during the teaching traveling, the type of the taught path RA, and the position information of the parking position P2 in association with each other in the path management DB 18A. In this case, the control unit 11 registers “exiting” in the path management DB 18A as a type corresponding to the exiting path data.

Therefore, in a case where the teaching traveling for the entering in the parking position P2 is performed, the type “entering”, the entering path data which is the taught path data, and the map data are registered in the path management DB 18A in association with the position information of the parking position P2. In addition, in a case where the teaching traveling for the exiting from the parking position P2 is performed, the type “exiting”, the exiting path data which is the taught path data, and the map data are registered in the path management DB 18A in association with the position information of the parking position P2. The control unit 11 may assign, to the map data, identification information for uniquely identifying the map data and register the map data in the path management DB 18A.

As described above, the taught path data includes a group of pieces of traveling information for each of positions which are the current positions sequentially estimated during the teaching traveling. The traveling information includes the outside situation acquired by the sensor device 14 at each position during the teaching traveling. Therefore, each of the entering path data of the entering path R1 and the exiting path data of the exiting path R2 may include the outside situation acquired by the sensor device 14.

Next, registration processing for the entering path data and the map data by the teaching traveling at the time of the entering will be described in detail.

The control unit 11 displays a button image for instructing the display device 22 of the traveling vehicle 1 to start parking registration.

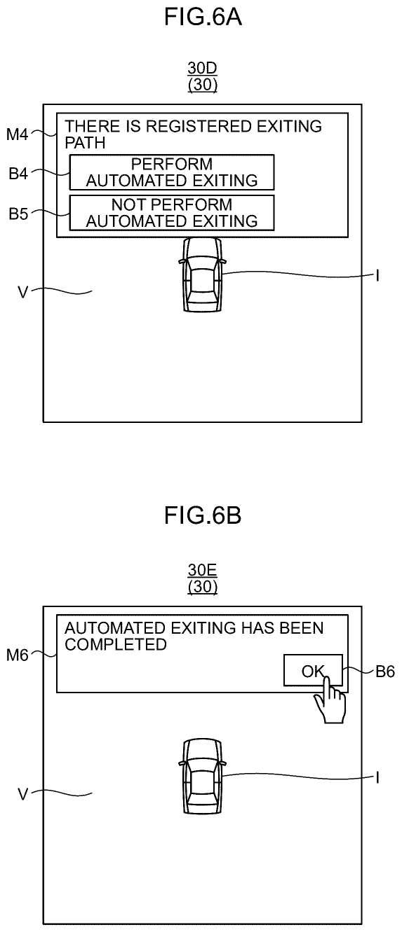

FIG. 5A is a schematic diagram of an example of a screen 30A. The screen 30A is an example of a screen 30 displayed on the display device 22.

The control unit 11 displays the screen 30A including a button image B1 for instructing to start parking registration on the display device 22 of the traveling vehicle 1. The screen 30A includes a video V captured by the second camera 16B, for example. The control unit 11 may further dispose and display an icon image I representing the vehicle 1 at a relative position corresponding to the current position of the vehicle 1 in the video V. The control unit 11 displays a button image for instructing to start parking registration by superimposing and displaying the button image B1 on the video V.

When a display region of the button image B1 on the screen 30A is operated according to an operation instruction of the operation device 20 by the occupant or the like, the control unit 11 determines that a parking registration start instruction has been received. When it is determined that the vehicle 1 has stopped by analyzing the sensor information and the like and it is determined that the parking registration start instruction has been received, the control unit 11 determines to start the teaching traveling mode for the entering.

Then, when the teaching traveling of the vehicle 1 is started by the driving operation of the vehicle 1 by the occupant, the control unit 11 sequentially stores the current positions of the vehicle 1 sequentially estimated during the teaching traveling of the vehicle 1. At this time, the control unit 11 assigns the INDEX to the current position, and sequentially stores the traveling position which is the current position, the azimuth, the traveling direction, and the reference traveling information in association with each other. In addition, the control unit 11 specifies the first feature points by performing image analysis on the video captured by the camera 16 during the teaching traveling, and sequentially registers the first feature points in the map data.

Then, the control unit 11 determines whether or not the vehicle 1 has stopped and a teaching traveling completion instruction for the entering has been received. For example, the control unit 11 causes the display device 22 to display information indicating a teaching traveling completion instruction operation for the entering.

FIG. 5B is a schematic diagram of an example of a screen 30B. The screen 30B is an example of the screen 30 displayed on the display device 22.

The control unit 11 causes the display device 22 to display the screen 30B including an indicator M2 representing the teaching traveling completion instruction operation for the entering and a button image B2 for the occupant to operate the teaching traveling completion instruction. The screen 30B may include the video V and the icon image I of the vehicle 1 as described above. The indicator M2 is information indicating the teaching traveling completion instruction operation for the entering.

FIG. 5B illustrates, as an example, a case where the teaching traveling completion instruction operation for the entering indicates an operation of completing parking and setting the shift lever to P (parking) or a button operation for switching the shift of the vehicle 1 to parking, and an operation of the button image B2. The operation of setting the shift lever to P (parking) or the button operation for switching the shift of the vehicle 1 to parking is an example of a parking switching operation.

FIG. 5B illustrates, as an example, a mode in which the indicator M2 is a text representing the teaching traveling completion instruction operation for the entering. The indicator M2 may be a still image, an animation image, an icon, or the like representing the teaching traveling completion instruction operation for the entering, and is not limited to the text.

When it is determined that the vehicle 1 has stopped and the teaching traveling completion instruction operation for the entering by the operation of the operation device 20 by the occupant has been received, the control unit 11 sets, as the entering path R1, the traveling path R during the teaching traveling represented by the group of the current positions sequentially estimated at the time of the teaching traveling, and registers, in the path management DB 18A, the entering path data representing the entering path R1, the map data in which the first feature points specified during the teaching traveling are registered, the position information of the parking position P2 representing the current position of the stopped vehicle 1, and the type “entering” in association with each other.

Then, the control unit 11 causes the display device 22 to display information indicating that the entering path R1 has been registered.

FIG. 5C is a schematic diagram of an example of a screen 30C. The screen 30C is an example of the screen 30 displayed on the display device 22.

The control unit 11 causes the display device 22 to display the screen 30C including an indicator M3 indicating that the entering path R1 has been registered and a button image B3 for receiving a confirmation operation by the occupant. The screen 30C may include the video V and the icon image I of the vehicle 1 as described above. The indicator M3 is information indicating that the entering path R1 has been registered. FIG. 5C illustrates, as an example, a mode in which the indicator M3 is a text indicating that the entering path R1 has been registered. The indicator M3 may be a still image, an animation image, an icon, or the like indicating that the entering path R1 has been registered, and is not limited to the text.

By these steps of processing, in a case where the teaching traveling for the entering from the parking start position P1 to the parking position P2 is performed, the type “entering”, the entering path data which is the taught path data, and the map data are registered in the path management DB 18A in association with the position information of the parking position P2.

Autonomous Traveling Mode Next, the control by the control unit 11 in the autonomous traveling mode will be described in detail.

When it is determined to start the autonomous traveling mode, the control unit 11 switches the traveling mode to the autonomous traveling mode. Then, the control unit 11 executes the following processing in the autonomous traveling mode.

At the time of the exiting, the control unit 11 reads the exiting path data and the map data associated with the parking position P2 indicated by the position information including the current position of the vehicle 1 from the path management DB 18A, and controls the movement control device 12 to perform autonomous traveling along the exiting path R2 indicated by the exiting path data. The autonomous traveling along the exiting path R2 may be referred to as automated exiting. The automated exiting means that the vehicle 1 autonomously travels from the parking position P2 to the target exiting position P3.

At the time of the entering, the control unit 11 reads the entering path data and the map data associated with the parking position P2 indicated by the position information including the target parking position from the path management DB 18A, and controls the movement control device 12 to perform autonomous traveling along the entering path R1 indicated by the entering path data. The autonomous traveling along the entering path R1 may be referred to as automated entering. The automated entering means that the vehicle 1 autonomously travels from the parking start position P1 to the parking position P2.

The control unit 11 estimates the current position of the vehicle 1 based on the map data and the video of the surroundings of the vehicle 1 acquired by at least one camera 16.

For example, the control unit 11 collates a second feature point specified from the second situation including the video of the camera 16 with the first feature specified from the first situation stored in the map data by using pattern matching, feature amount search, or the like.

The second feature point is a feature point obtained by analyzing the second situation such as the video captured by the camera 16 during the autonomous traveling along the taught path RA. That is, in the present embodiment, the feature point specified according to the second situation during the autonomous traveling along the taught path RA will be referred to as the second feature point. It is sufficient if the control unit 11 specifies the second feature point during the autonomous traveling along the taught path RA by using a method similar to the method of specifying the first feature points during the teaching traveling.

The control unit 11 randomly selects several (for example, three to six) second feature points among the second feature points specified during the autonomous traveling and collated with the first feature points stored in the map data.

Then, the control unit 11 estimates the current position of the vehicle 1 in the real space based on positions of the several second feature points in the video and the three-dimensional positions of the first feature points registered in the map data corresponding to the several second feature points in the real space. At this time, the control unit 11 estimates the current position of the vehicle 1 by solving a PnP problem using, for example, a known method such as Lambda Twist (for example, Literature: Mikael Persson et al. “Lambda Twist: An Accurate Fast Robust Perspective Three Point (P3P) Solver.”, ECCV 2018, pp 334-349, published in 2018, http://openaccess.thecvf.com/content ECCV 2018/papers/Mikael Persson Lambda_Twist_An_ECCV_2018_paper.pdf).

Through these steps of processing, the control unit 11 estimates, as current position information indicating the current position of the vehicle 1, current position information including information regarding a two-dimensional position (X coordinate, Y coordinate) of the vehicle 1 in the real space and a posture which is the orientation of the vehicle 1, based on the map data and the video of the surroundings of the vehicle 1 acquired by at least one camera 16.

Then, the control unit 11 causes the vehicle 1 to perform the autonomous traveling along the taught path RA by controlling the movement control device 12 such that the estimated current position of the vehicle 1 is a position on the taught path RA indicated by the taught path data.

During the autonomous traveling of the vehicle 1 along the taught path RA, the control unit 11 feedback-controls the movement control device 12 such that the vehicle 1 moves along the taught path RA based on the estimated current position of the vehicle 1 and each position on the taught path RA indicated by the taught path data. Therefore, the vehicle 1 autonomously travels along the taught path RA.

Here, as described above, in a case where the teaching traveling is performed, the taught path data and the map data are registered in the path management DB 18A in association with each parking position P2. However, in a case where the teaching traveling is not performed, the control unit 11 cannot perform the autonomous traveling along the taught path RA for the teaching traveling.

In the related art, the traveling path R until the vehicle 1 performs the entering in the parking position P2 is stored, and in a case where the vehicle 1 performs the exiting from the parking position P2, a path obtained by reversing the traveling path R is generated as a planned traveling path for exiting, and the vehicle 1 autonomously travels along the planned traveling path. That is, in the related art, a path obtained by reversing the entering path R1 for the entering in the parking position P2 is generated as the planned traveling path for exiting, and the automated exiting is performed along the planned traveling path.

However, for example, a path obtained by reversing a traveling path until the vehicle performs the entering in the parking position P2 may be different from an exiting path desired by the occupant, or a partial path where exiting traveling is impossible may be included, and thus, it may be difficult to use the path as the exiting path from the parking position P2. In addition, as described above, since the first feature points included in the map data generated during the teaching traveling for the entering are generated during the teaching traveling for the entering, in a case where the first feature points are directly used as the map data at the time of the automated exiting, it may be difficult to perform appropriate automated exiting according to road regulation information or the like. That is, it is difficult to provide suitable exiting assistance with the related art.

Therefore, in a case where the exiting path R2 from the parking position P2 to the target exiting position P3 has not been registered when starting the exiting from the parking position P2, the control unit 11 according to the present embodiment executes the following processing.

In this case, the control unit 11 causes the display device 22 to display first information prompting the occupant to determine whether or not to register the exiting path R2. Then, in a case where the operation device 20 receives a registration start instruction operation for the exiting path R2 by the occupant, the control unit 11 causes the vehicle 1 to travel from the parking position P2 to the target exiting position P3 according to the operation by the occupant received by the operation device 20. Then, the control unit 11 registers, as the exiting path R2, the traveling path R along which the traveling has been performed from the parking position P2 to the target exiting position P3.

Hereinafter, processing executed by the control unit 11 in the case of starting the exiting from the parking position P2 will be described in detail.

The control unit 11 determines whether or not the vehicle 1 in a power-off state has transitioned to a power-on state. In a case where the vehicle 1 in the power-off state has transitioned to the power-on state, the control unit 11 determines that the vehicle 1 starts the exiting from the parking start position P1. For example, it is sufficient if the control unit 11 performs the determination by determining whether or not an operation related to engine-on has been performed by the operation of the operation device 20 by the occupant. Furthermore, the control unit 11 may perform the determination by analyzing the sensor information and determining whether or not the vehicle 1 has transitioned to the power-on state.

Then, in the case of starting the exiting from the parking position P2, the control unit 11 determines whether or not the exiting path R2 from the parking position P2 to the target exiting position P3 has been registered. Specifically, the control unit 11 determines whether or not the exiting path R2 corresponding to the current parking position P2 of the vehicle 1 has been registered in the path management DB 18A. The control unit 11 performs the determination by determining whether or not the exiting path data and the map data has been registered in the path management DB 18A in association with the parking position P2 indicated by the position information including the current position information of the vehicle 1 and the type “exiting”.

In a case where it is determined that the exiting path R2 from the parking position P2 to the target exiting position P3 has been registered when starting the exiting from the parking position P2, the control unit 11 determines to start the autonomous traveling mode. Then, the control unit 11 controls at least the steering from the parking position P2 to the target exiting position P3 based on the exiting path R2 to cause the vehicle 1 to perform the autonomous traveling. In addition, the control unit 11 may control at least the steering and the acceleration and deceleration from the parking position P2 to the target exiting position P3 based on the exiting path R2 to cause the vehicle 1 to perform the autonomous traveling.

Specifically, in a case where the control unit 11 determines that the exiting path R2 from the parking position P2 to the target exiting position P3 has been registered when starting the exiting from the parking position P2, information for the occupant to select whether or not to perform the automated exiting is displayed.

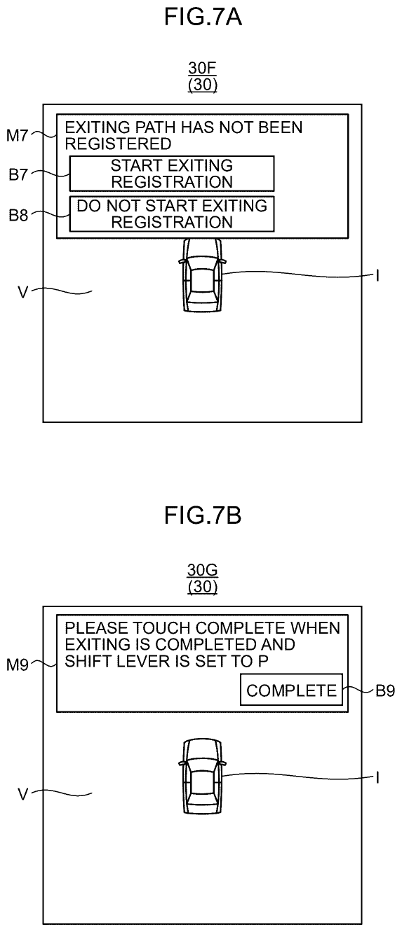

FIG. 6A is a schematic diagram of an example of a screen 30D. The screen 30D is an example of the screen 30 displayed on the display device 22.

The control unit 11 causes the display device 22 to display the screen 30D including an indicator M4 indicating that the exiting path R2 has been registered, a button image B4 for the occupant to select the automated exiting, and a button image B5 for the occupant to select not to perform the automated exiting. The screen 30D may include the video V and the icon image I of the vehicle 1 as described above. The indicator M4 is information indicating that the exiting path R2 has been registered. FIG. 6A illustrates an example in which the indicator M4 is a text indicating that the exiting path R2 has been registered. The indicator M4 may be a still image, an animation image, an icon, or the like indicating that the exiting path R2 has been registered, and is not limited to the text.

The control unit 11 determines whether or not selection of the button image B4 or the button image B5 has been received by the operation of the operation device 20 by the occupant, or whether or not the vehicle 1 has departed. It is sufficient if the control unit 11 determines whether or not the vehicle 1 has departed based on the sensor information or the like.

When it is determined that the selection of the button image B4 or the button image B5 by the operation of the operation device 20 by the occupant has been received or the vehicle 1 has departed, the control unit 11 determines whether or not the operation device 20 has received the selection of the button image B4 for the occupant to select the automated exiting. Then, when it is determined that the operation device 20 has received the selection of the button image B4 for the occupant to select the automated exiting, the control unit 11 determines to start the autonomous traveling mode and switches the traveling mode to the autonomous traveling mode. Then, the control unit 11 reads, from the path management DB 18A, the exiting path data and the map data registered in association with the parking position P2 indicated by the position information including the current position information of the vehicle 1 and the type “exiting”.

Then, the control unit 11 controls the movement control device 12 to perform the autonomous traveling along the exiting path R2 indicated by the read exiting path data. When it is determined that the vehicle 1 has performed autonomous traveling along the exiting path R2 and has reached the target exiting position P3 represented by the exiting path R2, the control unit 11 causes the display device 22 to display information indicating that the automated exiting has been completed.

FIG. 6B is a schematic diagram of an example of a screen 30E. The screen 30E is an example of the screen 30 displayed on the display device 22.

The control unit 11 causes the display device 22 to display the screen 30E including an indicator M6 indicating that the automated exiting has been completed and a button image B6 for receiving a confirmation operation by the occupant. The screen 30E may include the video V and the icon image I of the vehicle 1 as described above. The indicator M6 is information indicating that the automated exiting has been completed. FIG. 6B illustrates, as an example, a mode in which the indicator M6 is a text indicating that the automated exiting has been completed. The indicator M6 may be a still image, an animation image, an icon, or the like indicating that the automated exiting has been completed, and is not limited to the text.

When it is determined that an operation instruction of the button image B6 has been received by the operation of the operation device 20 by the occupant, it is sufficient if the control unit 11 deactivates the autonomous traveling mode and cause the vehicle 1 to travel according to the operation by the occupant received by the operation device 20. In addition, when it is determined that the operation device 20 has received the operation of the button image B5 included in the screen 30D and used by the occupant to select not to perform the automated exiting, it is sufficient if the control unit 11 does not switch the traveling mode to the autonomous traveling mode and causes the vehicle 1 to travel according to the operation by the occupant received by the operation device 20.

On the other hand, in a case where it is determined that the exiting path R2 from the parking position P2 to the target exiting position P3 has not been registered when starting the exiting from the parking position P2, the control unit 11 causes the display device 22 to display the first information prompting the occupant to determine whether or not to register the exiting path R2.

In addition, in a case where the control unit 11 controls at least the steering from the parking start position P1 to the parking position P2 based on the registered entering path R1 from the parking start position P1 to the parking position P2 to cause the vehicle 1 to perform the autonomous traveling, and then starts the exiting from the parking position P2, when it is determined that the exiting path R2 from the parking position P2 to the target exiting position P3 has not been registered, the control unit 11 may cause the display device 22 to display the first information prompting the occupant to determine whether or not to register the exiting path R2.

For example, the control unit 11 causes the display device 22 to display the first information including an indicator indicating that the exiting path R2 has not been registered and a button image for the occupant to select an operation as to whether or not to register the exiting path R2.

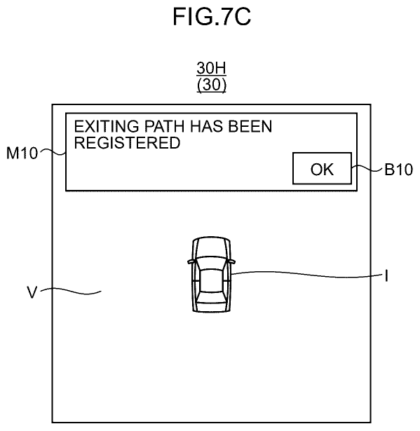

FIG. 7A is a schematic diagram of an example of a screen 30F. The screen 30F is an example of the screen 30 displayed on the display device 22, and is the screen 30 including the first information.

The control unit 11 causes the display device 22 to display the screen 30F including an indicator M7 indicating that the exiting path R2 has not been registered, a button image B7 for the occupant to select a registration start instruction for the exiting path R2, and a button image B8 for the occupant to select not to start the registration of the exiting path R2. The screen 30F may include the video V and the icon image I of the vehicle 1 as described above. The indicator M7 is information indicating that the exiting path R2 has not been registered. FIG. 7A illustrates, as an example, a mode in which the indicator M7 is a text indicating that the exiting path R2 has not been registered. The indicator M4 may be a still image, an animation image, an icon, or the like indicating that the exiting path R2 has not been registered, and is not limited to the text.

The control unit 11 determines whether or not selection of the button image B7 or the button image B8 by the operation of the operation device 20 by the occupant has been received or whether or not the vehicle 1 has departed. It is sufficient if the control unit 11 determines whether or not the vehicle 1 has departed based on the sensor information or the like.

When it is determined that the selection of the button image B7 or the button image B8 by the operation of the operation device 20 by the occupant has been received or the vehicle 1 has departed, the control unit 11 determines whether or not the operation device 20 has received the selection of the button image B7 for the occupant to select the registration start instruction for the exiting path R2.

When it is determined that the operation device 20 has received the selection of the button image B8, the control unit 11 determines that the operation device 20 has received a non-registration instruction operation for the exiting path R2 by the occupant. In this case, the control unit 11 does not execute registration processing for the exiting path R2.

On the other hand, when it is determined that the operation device 20 has received the selection of the button image B7, the control unit 11 determines that the operation device 20 has received the registration start instruction operation for the exiting path R2 by the occupant.

When the occupant has selected the button image B8 to select not to start the registration of the exiting path R2, that is, when the control unit 11 does not receive the registration start instruction operation for the exiting path R2 and causes the vehicle 1 to travel according to the operation by the occupant received by the operation device 20, the control unit 11 stops the display of the first information and does not perform the registration processing for the exiting path R2.

On the other hand, when the button image B7 has been selected by the occupant and the registration start instruction operation for the exiting path R2 has been received, the control unit 11 executes the following processing. In this case, the control unit 11 causes the vehicle 1 to travel from the parking position P2 to the target exiting position P3 according to the operation by the occupant received by the operation device 20, and registers, as the exiting path R2, the traveling path R along which the traveling has been performed from the parking position P2 to the target exiting position P3.

Specifically, in a case where the registration start instruction operation for the exiting path R2 has been received, the control unit 11 determines to start the teaching traveling mode and switches the traveling mode to the teaching traveling mode.

Then, when the teaching traveling of the vehicle 1 is started by the driving operation of the vehicle 1 by the occupant, the control unit 11 causes the vehicle 1 to travel from the parking position P2 to the target exiting position P3 according to the operation by the occupant received by the operation device 20. During the teaching traveling, the control unit 11 sequentially stores the map data and the current positions of the vehicle 1 in the storage device 18. Specifically, the control unit 11 sequentially stores the current positions of the vehicle 1 sequentially estimated during the teaching traveling of the vehicle 1. At this time, the control unit 11 assigns the INDEX to the current position, and sequentially stores the traveling position which is the current position, the azimuth, the traveling direction, and the reference traveling information in association with each other. In addition, the control unit 11 specifies the first feature points by performing image analysis on the video captured by the camera 16 during the teaching traveling, and sequentially registers the first feature points in the map data.

In addition, the control unit 11 causes the display device 22 to display a teaching traveling completion operation method for the registration of the exiting path R2.

FIG. 7B is a schematic diagram of an example of a screen 30G. The screen 30G is an example of the screen 30 displayed on the display device 22.

The control unit 11 causes the display device 22 to display the screen 30G including an indicator M9 indicating a teaching traveling completion instruction operation for the registration of the exiting path R2 and a button image B9 for receiving a registration execution operation for the exiting path R2. The screen 30G may include the video V and the icon image I of the vehicle 1 as described above. The indicator M9 is information indicating the teaching traveling completion instruction operation for the registration of the exiting path R2.

FIG. 7B illustrates, as an example, a case where the teaching traveling completion instruction operation for the registration of the exiting path R2 indicates an operation of completing parking and setting the shift lever to P (parking) or a button operation for switching the shift of the vehicle 1 to parking, and an operation of the button image B9 for receiving the registration execution operation for the exiting path R2. The operation of setting the shift lever to P (parking) or the button operation for switching the shift of the vehicle 1 to parking is an example of a parking switching operation.

FIG. 7B illustrates, as an example, a mode in which the indicator M9 is a text representing the teaching traveling completion instruction operation for the registration of the exiting path R2. The indicator M9 may be a still image, an animation image, an icon, or the like representing the teaching traveling completion instruction operation for registration of the exiting path R2, and is not limited to the text.

The control unit 11 registers the exiting path R2 when it is determined that the vehicle 1 has stopped, the parking switching operation, which is the teaching traveling completion instruction operation for the registration of the exiting path R2, has been received by the operation of the operation device 20 by the occupant, and the registration execution operation for the exiting path R2 has been received by the operation of the button image B9. Specifically, the control unit 11 sets, as the exiting path R2, the traveling path R during the teaching traveling represented by the group of the current positions sequentially estimated during the teaching traveling, and registers, in the path management DB 18A, the exiting path data representing the exiting path R2, the map data in which the first feature points specified during the teaching traveling are registered, the position information of the parking position P2 which is a start point of the teaching traveling for the exiting, and the type “exiting” in association with each other.

Then, the control unit 11 causes the display device 22 to display information indicating that the registration of the exiting path R2 has been completed.

FIG. 7C is a schematic diagram of an example of a screen 30H. The screen 30H is an example of the screen 30 displayed on the display device 22.

The control unit 11 causes the display device 22 to display the screen 30H including an indicator M10 indicating that the registration of the exiting path R2 has been completed and a button image B10 for receiving a confirmation operation by the occupant. The screen 30H may include the video V and the icon image I of the vehicle 1 as described above. The indicator M10 is information indicating that the registration of the exiting path R2 has been completed. FIG. 7C illustrates, as an example, a mode in which the indicator M10 is a text indicating that the registration of the exiting path R2 has been completed. The indicator M10 may be a still image, an animation image, an icon, or the like indicating that the registration of the exiting path R2 has been completed, and is not limited to the text.

When it is determined that an operation instruction of the button image B10 has been received by the operation of the operation device 20 by the occupant, it is sufficient if the control unit 11 deactivates the teaching traveling mode and cause the vehicle 1 to travel according to the operation by the occupant received by the operation device 20.

Next, an example of a flow of information processing executed by the vehicle control device 10 according to the present embodiment will be described.

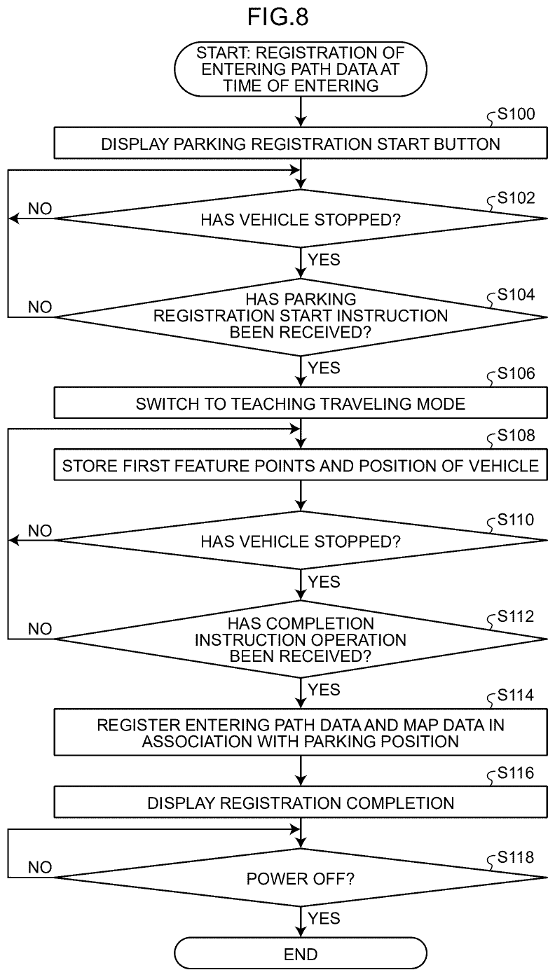

FIG. 8 is a flowchart illustrating an example of a flow of registration processing for the entering path data and the map data by the teaching traveling at the time of the entering.

The control unit 11 displays a button image for instructing to start parking registration on the display device 22 of the traveling vehicle 1 (step S100). By the processing of step S100, for example, the screen 30A illustrated in FIG. 5A is displayed on the display device 22.

Next, the control unit 11 determines whether or not the vehicle 1 has stopped (step S102). The control unit 11 repeats a negative determination (step S102: No) until an affirmative determination is made in step S102 (step S102: Yes). When it is determined that the vehicle 1 has stopped (step S102: Yes), the processing proceeds to step S104.

In step S104, the control unit 11 determines whether or not the parking registration start instruction has been received (step S104). The control unit 11 determines whether or not the button image B1 for instructing to start the parking registration included in the screen 30A displayed in step S100 has been operated by the operation instruction of the operation device 20 by the occupant, thereby making the determination of step S104.

When the control unit 11 makes a negative determination in step S104 (step S104: No), the processing returns to step S102. When the control unit 11 makes an affirmative determination in step S104 (step S104: Yes), the processing proceeds to step S106.

In step S106, the control unit 11 switches the traveling mode to the teaching traveling mode (step S106). Then, when the teaching traveling of the vehicle 1 is started by the driving operation of the vehicle 1 by the occupant, the control unit 11 sequentially stores the map data and the current positions of the vehicle 1 in the storage device 18 (step S108). Specifically, the control unit 11 sequentially stores the current positions of the vehicle 1 sequentially estimated during the teaching traveling of the vehicle 1. At this time, the control unit 11 assigns the INDEX to the current position, and sequentially stores the traveling position which is the current position, the azimuth, the traveling direction, and the reference traveling information in association with each other. In addition, the control unit 11 specifies the first feature points by performing image analysis on the video captured by the camera 16 during the teaching traveling, and sequentially registers the first feature points in the map data.

Then, the control unit 11 determines whether or not the vehicle 1 has stopped (step S110). When the control unit 11 makes a negative determination in step S110 (step S110: No), the processing returns to step S108. When it is determined that the vehicle 1 has stopped (step S110: Yes), the control unit 11 proceeds to step S112.

The control unit 11 determines whether or not the teaching traveling completion instruction operation for the entering has been received (step S112). For example, the control unit 11 causes the display device 22 to display the screen 30B which is the screen 30 including the information indicating the teaching traveling completion instruction operation for the entering (see FIG. 5B). Then, the control unit 11 determines whether or not the teaching traveling completion instruction operation for the entering, which includes the operation of completing parking and setting the shift lever to P (parking) or the button operation for switching the shift of the vehicle 1 to parking, and the operation of the button image B2 and is displayed on the screen 30B, has been received, thereby making the determination of step S112. When it is determined that the operation of setting the shift lever to P (parking) or the button operation for switching the shift of the vehicle 1 to parking has been performed according to the operation instruction of the operation device 20 by the occupant, and the operation of the button image B2 has been performed, the control unit 11 determines that the teaching traveling completion instruction operation for the entering has been received.

When the control unit 11 makes a negative determination in step S112 (step S112: No), the processing returns to step S108. When the control unit 11 makes an affirmative determination in step S112 (step S112: Yes), the processing proceeds to step S114.

In step S114, the control unit 11 sets, as the entering path R1, the traveling path R during the teaching traveling represented by the group of the current positions sequentially estimated during the teaching traveling, and registers, in the path management DB 18A, the entering path data representing the entering path R1, the map data in which the first feature points specified during the teaching traveling are registered, the position information of the parking position P2 representing the current position of the stopped vehicle 1, and the type “entering” in association with each other (step S114).

Then, the control unit 11 causes the display device 22 to display the information indicating that the entering path R1 has been registered (step S116). By the processing of step S116, for example, the screen 30C illustrated in FIG. 5C is displayed on the display device 22.

Next, the control unit 11 determines whether or not the vehicle 1 is in the power-off state (step S118). For example, it is sufficient if the control unit 11 performs the determination by determining whether or not an operation related to engine-off has been performed by the operation of the operation device 20 by the occupant. Furthermore, the control unit 11 may perform the determination by analyzing the sensor information and determining whether or not the vehicle 1 has transitioned to the power-off state. The control unit 11 repeats a negative determination (step S118: No) until an affirmative determination is made in step S118 (step S118: Yes). When the control unit 11 makes an affirmative determination in step S118 (step S118: Yes), this routine ends.

Next, a flow of information processing executed by the vehicle control device 10 in the case of starting the exiting from the parking position P2 will be described.

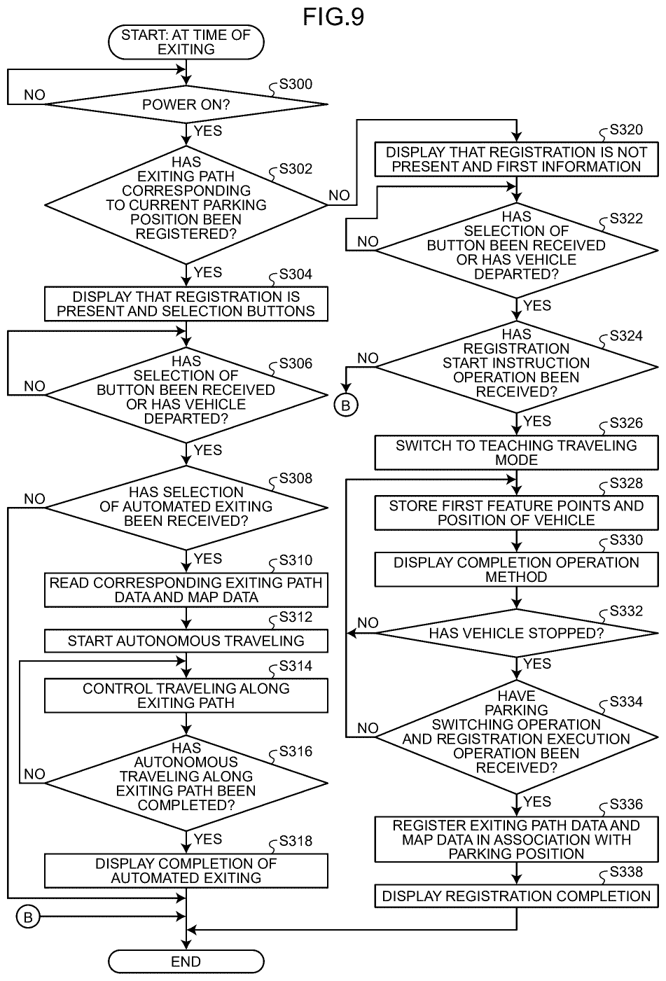

FIG. 9 is a flowchart illustrating an example of a flow of information processing executed by the vehicle control device 10 when the vehicle 1 performs the exiting.

The control unit 11 determines whether or not the vehicle 1 in the power-off state has transitioned to the power-on state (step S300). The control unit 11 repeats a negative determination (step S300: No) until an affirmative determination is made in step S300 (step S300: Yes). When an affirmative determination is made in step S300 (step S300: Yes), the control unit 11 determines that the vehicle 1 starts to perform the exiting from the parking start position P1, and proceeds to step S302.

In step S302, the control unit 11 determines whether or not the exiting path R2 from the parking position P2 to the target exiting position P3 has been registered (step S302). The control unit 11 determines whether or not the exiting path R2 corresponding to the current parking position P2 of the vehicle 1 has been registered in the path management DB 18A, thereby performing the determination of step S302.

In a case where it is determined that the exiting path R2 has been registered in the path management DB 18A (step S302: Yes), the processing proceeds to step S304.

In step S304, the control unit 11 displays information for the occupant to select whether or not to perform the automated exiting (step S304). By the processing of step S304, for example, the control unit 11 displays the screen 30D illustrated in FIG. 6A on the display device 22. The screen 30D includes the indicator M4 indicating that the exiting path R2 has been registered, the button image B4 for the occupant to select the automated exiting, and the button image B5 for the occupant to select not to perform the automated exiting.

The control unit 11 determines whether or not the selection of the button image B4 or the button image B5 by the operation of the operation device 20 by the occupant has been received or whether or not the vehicle 1 has departed (step S306). The control unit 11 repeats a negative determination (step S306: No) until an affirmative determination is made in step S306 (step S306: Yes). When an affirmative determination is made in step S306 (step S306: Yes), the control unit 11 proceeds to step S308.

In step S308, the control unit 11 determines whether or not the operation device 20 has received the selection of the automated exiting (step S308). The control unit 11 determines whether or not the operation device 20 has received the selection of the button image B4 included in the screen 30D displayed in step S304 and used by the occupant to select the automated exiting, thereby making the determination of step S308. When a negative determination is made in step S308 (step S308: No), this routine ends. A case where a negative determination is made in step S308 includes a case where the button image B5 included in the screen 30D and used by the occupant to select not to perform the automated exiting is operated by the occupant.

When an affirmative determination is made in step S308 (step S308: Yes), the control unit 11 proceeds to step S310. The control unit 11 reads the exiting path data and the map data registered in association with the parking position P2 indicated by the position information including the current position information of the vehicle 1 and the type “exiting” from the path management DB 18A (step S310).

Then, the control unit 11 causes the vehicle 1 to start the autonomous traveling along the exiting path R2 indicated by the exiting path data read in step S310 (step S312).

The control unit 11 controls the movement control device 12 to perform the autonomous traveling along the exiting path R2 indicated by the exiting path data read in step S310 (step S314). That is, the control unit 11 causes the vehicle 1 to perform the autonomous traveling along the exiting path R2 from the parking position P2 toward the target exiting position P3 by controlling the movement control device 12 such that the current position of the vehicle 1 included in the sensor information that is the second situation acquired from the sensor device 14 is a position on the exiting path R2 indicated by the exiting path data.

Next, the control unit 11 determines whether or not the autonomous traveling along the exiting path R2 has been completed (step S316). For example, the control unit 11 performs the determination of step S316 by determining whether or not the vehicle 1 has reached the target exiting position P3 represented by the exiting path R2. When the control unit 11 makes a negative determination in step S316 (step S316: No), the processing returns to step S314. When the control unit 11 makes an affirmative determination in step S316 (step S316: Yes), the processing proceeds to step S318.

In step S318, the control unit 11 causes the display device 22 to display the information indicating that the automated exiting has been completed (step S318). By the processing of step S318, for example, the screen 30E illustrated in FIG. 6B is displayed on the display device 22. Then, this routine ends.

On the other hand, in a case where the control unit 11 determines that the exiting path R2 from the parking position P2 to the target exiting position P3 has not been registered (step S302: No), the processing proceeds to step S320.

The control unit 11 causes the display device 22 to display the first information prompting the occupant to determine whether or not to register the exiting path R2 (step S320). By the processing of step S320, for example, the screen 30F illustrated in FIG. 7A is displayed on the display device 22. As described above, the screen 30F includes the indicator M7 indicating that the exiting path R2 has not been registered, the button image B7 for the occupant to select the registration start instruction for the exiting path R2, and the button image B8 for the occupant to select not to start the registration of the exiting path R2.

The control unit 11 determines whether or not the selection of the button image B7 or the button image B8 by the operation of the operation device 20 by the occupant has been received or whether or not the vehicle 1 has departed (step S322). The control unit 11 repeats a negative determination (step S322: No) until an affirmative determination is made in step S322 (step S322: Yes). When the control unit 11 makes an affirmative determination in step S322 (step S322: Yes), the processing proceeds to step S324.

In step S324, the control unit 11 determines whether or not the operation device 20 has received the selection of the button image B7 for the occupant to select the registration start instruction for the exiting path R2 (step S324).

When the control unit 11 makes a negative determination in step S324 (step S324: No), this routine ends. That is, when it is determined that the operation device 20 has received the selection of the button image B8 for the occupant to select not to start the registration of the exiting path R2, the control unit 11 determines that the operation device 20 has received the non-registration instruction operation for the exiting path R2 by the occupant. In this case, the control unit 11 ends this routine without executing the registration processing for the exiting path R2.

On the other hand, when the control unit 11 makes an affirmative determination in step S324 (step S324: Yes), the processing proceeds to step S326. In step S326, the control unit 11 switches the traveling mode to the teaching traveling mode (step S326).

Then, when the teaching traveling of the vehicle 1 is started by the driving operation of the vehicle 1 by the occupant, the control unit 11 causes the vehicle 1 to travel from the parking position P2 to the target exiting position P3 according to the operation by the occupant received by the operation device 20 (step S328). During the teaching traveling, the control unit 11 sequentially stores the map data and the current positions of the vehicle 1 in the storage device 18. Specifically, the control unit 11 sequentially stores the current positions of the vehicle 1 sequentially estimated during the teaching traveling of the vehicle 1. At this time, the control unit 11 assigns the INDEX to the current position, and sequentially stores the traveling position which is the current position, the azimuth, the traveling direction, and the reference traveling information in association with each other. In addition, the control unit 11 specifies the first feature points by performing image analysis on the video captured by the camera 16 during the teaching traveling, and sequentially registers the first feature points in the map data.

Then, the control unit 11 causes the display device 22 to display the teaching traveling completion operation method for the registration of the exiting path R2 during the teaching traveling (step S330). By the processing of step S330, for example, the screen 30G illustrated in FIG. 7B is displayed on the display device 22.

The control unit 11 determines whether or not the vehicle 1 has stopped (step S332). When the control unit 11 makes a negative determination in step S332 (step S332: No), the processing returns to step S328. When the control unit 11 makes an affirmative determination in step S332 (step S332: Yes), the processing proceeds to step S334.

In step S334, the control unit 11 determines whether or not the parking switching operation, which is the teaching traveling completion instruction operation for the registration of the exiting path R2, has been received by the operation of the operation device 20 by the occupant and the registration execution operation for the exiting path R2 has been received by the operation of the button image B9 (step S334). As described above, the parking switching operation is, for example, the operation of setting the shift lever to P (parking) by the occupant or the button operation for switching the shift of the vehicle 1 to parking. When a negative determination is made in step S334 (step S334: No), the processing returns to step S328. When the control unit 11 makes an affirmative determination in step S334 (step S334: Yes), the processing proceeds to step S336.

In step S336, the control unit 11 sets, as the exiting path R2, the traveling path R during the teaching traveling represented by the group of the current positions sequentially estimated during the teaching traveling, and registers, in the path management DB 18A, the exiting path data representing the exiting path R2, the map data in which the first feature points specified during the teaching traveling are registered, the position information of the parking position P2 which is a start point of the teaching traveling for the exiting, and the type “exiting” in association with each other (step S336).

Then, the control unit 11 causes the display device 22 to display the information indicating that the registration of the exiting path R2 has been completed (step S338). By the processing of step S338, for example, the screen 30H illustrated in FIG. 7C is displayed on the display device 22. Then, this routine ends.

As described above, the vehicle control device 10 according to the present embodiment is mounted on the vehicle 1 including the operation device 20 that receives the operation of the occupant, the sensor device 14 that acquires the outside situation including the video of the area outside the vehicle 1, the display device 22 that is visually recognizable by the occupant, and the movement control device 12 that controls at least the steering. In a case where the exiting path R2 from the parking position P2 to the target exiting position P3 has been registered when starting the exiting from the parking position P2, the control unit 11 of the vehicle control device 10 controls at least the steering from the parking position P2 to the target exiting position P3 based on the exiting path 42 to cause the vehicle 1 to perform the autonomous traveling. In a case where the exiting path R2 from the parking position P2 to the target exiting position P3 has not been registered when starting the exiting from the parking position P2, the control unit 11 causes the display device 22 to display the first information prompting the occupant to determine whether or not to register the exiting path R2. In a case where the operation device 20 has received the registration start instruction operation for the exiting path R2 by the occupant, the control unit 11 causes the vehicle 1 to travel from the parking position P2 to the target exiting position P3 according to the operation by the occupant received by the operation device 20, and registers, as the exiting path R2, the traveling path R along which the traveling has been performed from the parking position P2 to the target exiting position P3.

In the related art, the traveling path R until the vehicle 1 performs the entering in the parking position P2 is stored, and in a case where the vehicle 1 performs the exiting from the parking position P2, a path obtained by reversing the traveling path R is generated as a planned traveling path for exiting, and the vehicle 1 autonomously travels along the planned traveling path. That is, in the related art, a path obtained by reversing the entering path R1 for the entering in the parking position P2 is generated as the planned traveling path for exiting, and the automated exiting is performed along the planned traveling path.

However, for example, a path obtained by reversing a traveling path until the vehicle performs the entering in the parking position P2 may be different from an exiting path desired by the occupant, or a partial path where exiting traveling is impossible may be included, and thus, it may be difficult to use the path as the exiting path from the parking position P2. In addition, as described above, since the first feature points included in the map data generated during the teaching traveling for the entering are generated during the teaching traveling for the entering, in a case where the first feature points are directly used as the map data at the time of the automated exiting, it may be difficult to perform appropriate automated exiting according to road regulation information or the like. That is, it is difficult to provide suitable exiting assistance with the related art.

On the other hand, in a case where the exiting path R2 from the parking position P2 to the target exiting position P3 has not been registered when starting the exiting from the parking position P2, the vehicle control device 10 according to the present embodiment causes the display device 22 to display the first information prompting the occupant to determine whether or not to register the exiting path R2. In a case where the operation device 20 has received the registration start instruction operation for the exiting path R2 by the occupant, the vehicle control device 10 causes the vehicle 1 to travel from the parking position P2 to the target exiting position P3 according to the operation by the occupant received by the operation device 20, and registers, as the exiting path R2, the traveling path R along which the traveling has been performed from the parking position P2 to the target exiting position P3.

As described above, in the vehicle control device 10 according to the present embodiment, in a case where the exiting path R2 from the parking position P2 of the vehicle 1 to the target exiting position P3 has been registered when the vehicle 1 performs the exiting, the automated exiting along the exiting path R2 is performed, and in a case where the exiting path R2 from the parking position P2 of the vehicle 1 to the target exiting position P3 has not been registered when the vehicle 1 performs the exiting, the vehicle control device 10 according to the present embodiment creates and registers the exiting path R2 for the automated exiting by the teaching traveling for the exiting instead of using the entering path R1 to the parking position P2. Therefore, the vehicle control device 10 according to the present embodiment can provide suitable exiting assistance.

Therefore, the vehicle control device 10 and the vehicle control method according to the present embodiment can provide suitable exiting assistance.

Next, a hardware configuration of the vehicle control device 10 according to the present embodiment will be described.

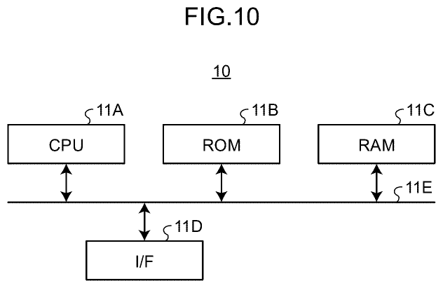

FIG. 10 is a block diagram illustrating a hardware configuration example of the vehicle control device 10.

The vehicle control device 10 has a hardware configuration using a normal computer in which a central processing unit (CPU) 11A, a read only memory (ROM) 11B, a random access memory (RAN) 11C, an interface (I/F) 11D for connecting to various devices, and the like are connected to one another by a bus 11E.

The CPU 11A is an arithmetic device that controls the entire processing of the vehicle control device 10. The RAM 11C stores data necessary for various types of processing executed by the CPU 11A. The ROM 11B stores a program or the like that implements various types of processing executed by the CPU 11A. The I/F 11D is an interface that is connected to an external device or an external terminal via a communication line or the like and transmits and receives data to and from the connected external device or external terminal.

A program for executing the above-described various types of processing executed by the vehicle control device 10 is provided by being incorporated in the ROM 11B or the like in advance. A program for executing the vehicle control method executed in the present embodiment may be provided by being recorded in a computer-readable recording medium such as a CD-ROM, a flexible disk (FD), a CD-R, or a digital versatile disc (DVD) as a file in a format installable or executable in these devices.

In addition, the program for executing the vehicle control method executed in the present embodiment may be stored on a computer connected to a network such as the Internet and provided by being downloaded via the network. In addition, the program for executing the vehicle control method executed in the present embodiment may be provided or distributed via a network such as the Internet.

With the vehicle control method and the vehicle control device according to the present disclosure, it is possible to provide suitable exiting assistance.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A vehicle control method executed by a vehicle control device mounted on a vehicle including an operation device that receives an operation of an occupant, a sensor device that acquires an outside situation, a display device that is visually recognizable by the occupant, and a movement control device that controls at least steering, the vehicle control method comprising:
controlling at least steering to cause the vehicle to perform autonomous traveling from a parking position to a target exiting position based on an exiting path in a case where the exiting path from the parking position to the target exiting position has been registered when starting exiting from the parking position;
causing the display device to display first information prompting the occupant to determine whether or not to register the exiting path in a case where the exiting path from the parking position to the target exiting position has not been registered when starting the exiting from the parking position; and
causing the vehicle to travel from the parking position to the target exiting position according to the operation by the occupant received by the operation device, and registering, as the exiting path, a traveling path along which traveling has been performed from the parking position to the target exiting position in a case where the operation device has received a registration start instruction operation for the exiting path by the occupant.

2. The vehicle control method according to claim 1, wherein
the exiting path is registered in association with the parking position.

3. The vehicle control method according to claim 1, wherein
the display device is made to display the first information in a case where the exiting path from the parking position to the target exiting position has not been registered when starting the exiting from the parking position, and
the exiting path is not registered in a case where the operation device has received a non-registration instruction operation for the exiting path by the occupant.

4. The vehicle control method according to claim 1, wherein in a case where at least steering is controlled to cause the vehicle to perform the autonomous traveling from a parking start position to the parking position based on a registered entering path from the parking start position to the parking position, and then the exiting from the parking position is started,
the display device is made to display the first information in a case where the exiting path from the parking position to the target exiting position has not been registered.

5. The vehicle control method according to claim 1, wherein in a case where the exiting path from the parking position to the target exiting position has not been registered when starting the exiting from the parking position, the display device is made to display the first information, and
in a case where the operation device does not receive the registration start instruction operation for the exiting path by the occupant and the vehicle is made to travel according to the operation by the occupant received by the operation device, the display device is made to stop displaying the first information.

6. The vehicle control method according to claim 1, wherein
in a case where the exiting path from the parking position to the target exiting position has not been registered when starting the exiting from the parking position, the display device is made to display the first information, and
in a case where the operation device has received the registration start instruction operation for the exiting path by the occupant, the vehicle is made to travel from the parking position to the target exiting position according to the operation by the occupant received by the operation device, and the traveling path along which the traveling has been performed from the parking position to the target exiting position is registered as the exiting path together with the outside situation acquired by the sensor device.

7. The vehicle control method according to claim 1, wherein
in a case where the operation device has received the registration start instruction operation for the exiting path by the occupant, the vehicle is made to travel from the parking position to the target exiting position according to the operation by the occupant received by the operation device, and in a case where the operation device has received a registration execution operation for the exiting path by the occupant, the exiting path is registered.

8. The vehicle control method according to claim 7, wherein
in a case where the operation device has received the registration start instruction operation for the exiting path by the occupant, the vehicle is made to travel from the parking position to the target exiting position according to the operation by the occupant received by the operation device, and in a case where the vehicle has stopped, and the operation device has received the registration execution operation for the exiting path by the occupant, the exiting path is registered.

9. The vehicle control method according to claim 8, wherein
in a case where the operation device has received the registration start instruction operation for the exiting path by the occupant, the vehicle is made to travel from the parking position to the target exiting position according to the operation by the occupant received by the operation device, and the exiting path is registered in a case where the vehicle has stopped, the operation device has received a parking switching operation, and the operation device has received the registration execution operation for the exiting path by the occupant.

10. The vehicle control method according to claim 1, wherein
at least steering and acceleration and deceleration are controlled to cause the vehicle to perform the autonomous traveling from the parking position to the target exiting position based on the exiting path in a case where the exiting path from the parking position to the target exiting position has been registered when starting the exiting from the parking position.

11. A vehicle control device mounted on a vehicle including an operation device that receives an operation of an occupant, a sensor device that acquires an outside situation, a display device that is visually recognizable by the occupant, and a movement control device that controls at least steering, the vehicle control device comprising
circuitry configured to:
control at least steering to cause the vehicle to perform autonomous traveling from a parking position to a target exiting position based on an exiting path in a case where the exiting path from the parking position to the target exiting position has been registered when starting exiting from the parking position,
cause the display device to display first information prompting the occupant to determine whether or not to register the exiting path in a case where the exiting path from the parking position to the target exiting position has not been registered when starting the exiting from the parking position, and
cause the vehicle to travel from the parking position to the target exiting position according to the operation by the occupant received by the operation device, and register a traveling path along which traveling has been performed from the parking position to the target exiting position as the exiting path in a case where the operation device has received a registration start instruction operation for the exiting path by the occupant.

12. The vehicle control device according to claim 11, wherein
the circuitry configured to register the exiting path in association with the parking position.

13. The vehicle control device according to claim 11, wherein the circuitry configured to:
cause the display device to display the first information in a case where the exiting path from the parking position to the target exiting position has not been registered when starting the exiting from the parking position; and
not register the exiting path in a case where the operation device has received a non-registration instruction operation for the exiting path by the occupant.

14. The vehicle control device according to claim 11, wherein the circuitry configured to
in a case where at least steering is controlled to cause the vehicle to perform the autonomous traveling from a parking start position to the parking position based on a registered entering path from the parking start position to the parking position, and then the exiting from the parking position is started,
cause the display device to display the first information in a case where the exiting path from the parking position to the target exiting position has not been registered.

15. The vehicle control device according to claim 11, wherein the circuitry configured to:
in a case where the exiting path from the parking position to the target exiting position has not been registered when starting the exiting from the parking position, cause the display device to display the first information; and
in a case where the operation device does not receive the registration start instruction operation for the exiting path by the occupant and when causing the vehicle to travel according to the operation by the occupant received by the operation device, cause the display device to stop displaying the first information.

16. The vehicle control device according to claim 11, wherein the circuitry configured to:
in a case where the exiting path from the parking position to the target exiting position has not been registered when starting the exiting from the parking position, cause the display device to display the first information; and
in a case where the operation device has received the registration start instruction operation for the exiting path by the occupant, cause the vehicle to travel from the parking position to the target exiting position according to the operation by the occupant received by the operation device, register the traveling path along which the traveling has been performed from the parking position to the target exiting position as the exiting path together with the outside situation acquired by the sensor device.

17. The vehicle control device according to claim 11, wherein
the circuitry configured to, in a case where the operation device has received the registration start instruction operation for the exiting path by the occupant, cause the vehicle to travel from the parking position to the target exiting position according to the operation by the occupant received by the operation device, and in a case where the operation device has received a registration execution operation for the exiting path by the occupant, register the exiting path.

18. The vehicle control device according to claim 17, wherein
the circuitry configured to, in a case where the operation device has received the registration start instruction operation for the exiting path by the occupant, cause the vehicle to travel from the parking position to the target exiting position according to the operation by the occupant received by the operation device, and in a case where the vehicle has stopped, and the operation device has received the registration execution operation for the exiting path by the occupant, register the exiting path.

19. The vehicle control device according to claim 18, wherein
the circuitry configured to, in a case where the operation device has received the registration start instruction operation for the exiting path by the occupant, cause the vehicle to travel from the parking position to the target exiting position according to the operation by the occupant received by the operation device, and in a case where the vehicle has stopped, the operation device has received a parking switching operation, and the operation device has received the registration execution operation for the exiting path by the occupant, register the exiting path.

20. The vehicle control device according to claim 11, wherein
the circuitry configured to control at least steering and acceleration and deceleration to cause the vehicle to perform the autonomous traveling from the parking position to the target exiting position based on the exiting path in a case where the exiting path from the parking position to the target exiting position has been registered when starting the exiting from the parking position.
